(19) United States
(12) Patent Application Publication
(10) Pub. No.: US 2008/0205651 A1
(43) Pub. Date: Aug. 28, 2008

(54) Secure processor system without need for manufacturer and user to know encryption information of each other

(75) Inventors: Seiji Goto, Kawasaki (JP); Hidenori Koyama, Kawasaki (JP); Jun Kamada, Kawasaki (JP); Shinya Mukai, Kawasaki (JP); Taiji Tamiya, Kawasaki (JP); Makoto Nakahara, Kawasaki (JP); Makoto Nishikata, Kawasaki (JP); Chiduka Tsuruoka, Kawasaki (JP); Arata Noguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/004,423

(22) Filed: Dec. 21, 2007

(30) Foreign Application Priority Data
Feb. 27, 2007 (JP) 2007-047178

(51) Int. Cl. H04L 9/00

(52) U.S. Cl. 380/277; 713/189

(57) ABSTRACT

A secure processor system capable of improving the security of processor processing by the addition of minimum modules without the need for a manufacturer and a user to know encryption information of each other has been disclosed. The secure processor system includes a secure processor having a CPU core that executes a instruction code, an encryption key hold part that holds a processor key, and an encryption processing part that encrypts or decrypts data input/output to/from the core with a processor key and a memory, and the encryption key hold part includes a hardware register that holds a hardwired encryption key, a write only register that stores an encryption key for instruction to be input and holds the stored encryption key for instruction so that it cannot be read, and the encryption key hold part outputs a hardware encryption key as a processor key at the time of activation and outputs a command encryption key as a processor key after a encryption key for instruction is written.

### CROSS-REFERENCE TO RELATED APPLICATION

This application is based upon and claims priority from prior Japanese Patent Application No. 2007-047178, filed on Feb. 27, 2007, the entire contents of which are incorporated herein by reference.

### BACKGROUND OF THE INVENTION

The embodiment relates to a system having a processor, and more specifically, to a secure processor system capable of preventing an unauthorized code from being executed, a secure processor for constructing such a system, and a method of controlling a secure processor system.

In a system that uses a processor, its operation can be defined by programs, and therefore, the system is more flexible in design and operation compared to a system in which all of the components are comprised of hardware, and a variety of kinds of function can be easily realized. Due to this advantage, processors are now mounted in various computers, such as a personal computers etc., and various information devices, such as PDAs (Personal Digital Assistant), mobile phones, information home electronic appliances, etc.

FIG. 1A is a diagram showing a general configuration of a system that uses a conventional processor. As shown schematically, the system has a processor 1 and an external ROM 6. Generally, the processor 1 has a CPU core 2 that carries out command processing, a built-in ROM 4 used for activation, a memory interface (IF) 5 for communicating with an internal or external memory, and an internal bus 3 that mutually connects the modules, and is formed into a one-chip semiconductor. In some cases, the built-in ROM 4 may not be provided and in such a case, the processor is activated from the outside via the memory interface. In addition, other peripheral blocks may also be mounted. However, these cases are not explained here because they have a limited relationship with the embodiment. The external ROM 6 stores a control program 7 used to operate a processor 1.

In this configuration, programs are stored in a rewritable external storage medium (for example flash ROM) 6 in order for the processor to carry out desired operations. However, such a configuration is very vulnerable to an outside deciphering, for example, the physical removal of ROM 6, ie., if the internal processing program is highly sensitive, ie., management of copyright, secure processing can not be ensured in the system, and as a result, such a system cannot be realized.

As networks become more developed, information devices will more likely be connected to a network, or networks, and mail and other data will become more frequently transmitted and received via networks, and programs will also be more frequently downloaded via networks. In such circumstances, the danger of infection by a computer virus via a network etc., and unauthorized access has increased recently, and therefore, the security of programs executed by computers and mobile information terminals is more important as networks become more widely used.

Various systematic measures, such as encryption of data, user authentication, etc., are used in order to secure a robust information device comprising a processor. However, recently, the security of software and processors has become important in order to cope with the spread of computer viruses and unauthorized access, in addition to the security of systems.

For example, the connection of various processor-incorporated devices, such as mobile phones, information home electronic appliances, etc., to a network increases the possibility that these devices are exposed to the same risks as personal computers etc. Unauthorized access becomes active by the execution of an executable code with malicious intent in its terminal. Because of this, it is necessary to prevent codes with malicious intent and undesired codes from being executed in the processor. However, at present, the countermeasures on the processor side to prevent codes with malicious intent from being executed are not sufficient and there is a problem in that no safety software execution environment is provided.

In order to solve this problem, recently, a secure processor has been studied. A secure processor makes it impossible to read data directly by encrypting data handled outside the processor and providing access protection to the inside. For example, data and command codes are encrypted and stored in a main storage device or a secondary storage device and when the processor executes the command, the encrypted command codes are decrypted and stored in a cache memory, and then executed.

The present applicants have disclosed such a secure processor in Japanese Unexamined Patent Publication (Kokai) No. 2006-18528 (JP2006-18528A).

FIG. 1B is a diagram showing the basic configuration of the secure processor disclosed in JP2006-18528A. As shown schematically, a secure processor 10 has a (CPU) core 11 including an execution unit and a cache, an encryption processing block 12 that carries out command processing with an external interface, encryption and decryption of bus data (program codes or data), etc., a code authentication processing block 13 that carries out the authentication of command codes, an encrypted ROM code region 14 in which the most fundamental programs etc., used to activate the processor are encrypted and stored, and a CPU unique key hold register 15 that holds a CPU unique key for decrypting the programs etc., stored in code region 14.

Then, between the core 11 and the encryption processing block 12, commands and data are exchanged and control of keys for encryption is carried out, and between core 11 and code authentication processing block 13, an authentication interface is provided. Further, encryption processing block 12 and code authentication processing block 13 access a main memory 17 and code authentication block 13 accesses a secondary memory 18.

In the secure processor disclosed in JP2006-18528A, the CPU unique key hold register 15 cannot be accessed from the outside. After determining a CPU unique key, the user (system manufacturer) of the secure processor notifies the manufacturer of the CPU unique key and the manufacturer sets the notified CPU unique key to CPU unique key hold register 15 when manufacturing the processor. Then, the manufacturer and the user keep the CPU unique key under strict surveillance to prevent it from leaking to the outside. The secure processor will not operate with programs other than the program correctly encrypted using the CPU unique key. Therefore, even if the program is changed with malicious intent by a third party with malicious intent who does not know the CPU unique key, it is impossible to cause the secure processor to operate in an unauthorized manner.

Although the secure processor described in JP2006-18528A is functional, the system itself as well as its hardware and software are required to be modified considerably from conventional systems. In other words, there is a problem in that it is difficult to maintain compatibility with conventional systems. When providing a very secure processor, an increase in cost of the compatibility has to be accepted to a certain degree, however, it is desired that the processor minimize the amount of modification and transitional cost from the conventional systems.

Further, as described above, it is necessary to keep the CPU unique key under strict surveillance by the manufacturer and user, however, keeping under strict surveillance requires extra expense and it is necessary for the manufacturer who keeps a number of user's CPU unique keys to keep the CPU unique key for each chip, resulting in a heavy burden. When the manufacturer has to manage a number of CPU unique keys all together, the leak out of user's CPU unique keys causes a simultaneous leak out of many keys resulting in user's systems becoming infecting with a virus. Because of this, the cost to keep the CPU unique key affects manufacturing cost and increases the price of a secure processor.

From this standpoint, it is desirable to maintain a certain security level as a secure processor even if the manufacturer and the user of the secure processor do not know each other encryption information. This not only removes the need for a manufacturer to manage a user's encryption, but also brings about an advantage of to a user that there is no longer the possibility of encryption from the manufacturer from leaking.

A first object of the embodiment is to realize the security of processor processing by the addition of minimum modules and minimize the influence on existing systems.

A second object of the embodiment is to provide items, such as unique information for each chip, which affect manufacturing cost, by a substitutive means and realize it at a low cost. Specifically, the object is to remove the need for a manufacturer and user to know the encryption information of each other and the management of the encryption information.

### SUMMARY

According to an aspect of an embodiment, a secure processor system having a secure processor having a core that executes a instruction code, an encryption key hold part that holds a processor key, and an encryption processing part that encrypts or decrypts data input/output to/from the core with the processor key, and a memory that stores the data input/output to/from the core is provided. The encryption key hold part of the secure processor having a hardware register that holds a hardwired encryption key that cannot be rewritten or read, and a write only register that stores a encryption key for instruction to be input and holds the stored encryption key for instruction so that it cannot be read. The encryption key hold part outputs the hardware encryption key held in the hardware register as the processor key when the processor is activated, and after the command encryption key is written to the write only register, outputs the command encryption key held in the write only register as the processor key.

### BRIEF DESCRIPTION OF THE DRAWINGS

The features and advantages of the embodiment will be more clearly understood from the following description taken in conjunction with accompanying drawings, in which:

FIG. 1A is a diagram showing a configuration of a conventional processor;

FIG. 1B is a diagram showing a configuration of a conventional secure processor;

FIG. 2 is a diagram for explaining the principles of a secure processor system of the embodiment;

FIG. 3 is a diagram showing a configuration of a secure processor system in an embodiment;

FIGS. 4A and 4B are diagrams for explaining the creation of an encryption ROM;

FIGS. 5a and 5B are diagrams showing a dataflow when creating an encryption ROM;

FIG. 6 is a flowchart showing a procedure for creating an encryption ROM;

FIG. 7 is a flowchart showing a procedure for updating an encryption ROM;

FIG. 8 is a diagram showing a configuration of an encryption processing part;

FIG. 9 is a diagram showing a configuration of an encryption determination part and encryption key hold part;

FIG. 10 is a flowchart showing an operation in a secure processor in an embodiment; and

FIG. 11 is a diagram showing a relationship between debugger detection and authorized user authentication.

### DESCRIPTION OF THE PREFERRED EMBODIMENTS

An embodiment is explained below with reference to the drawings.

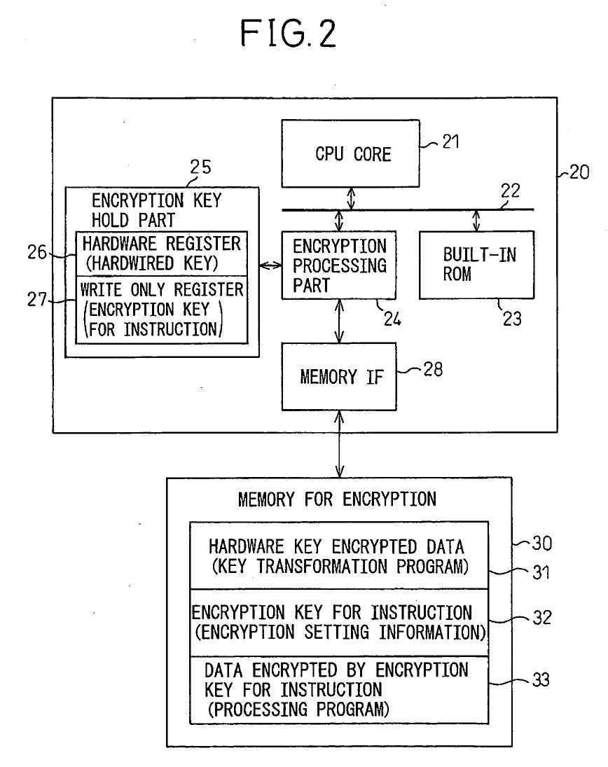

FIG. 2 is a diagram explaining the principles of the embodiment. As shown in FIG. 2, the secure processor system of the embodiment comprises a secure processor 20 and a memory for encryption 30. Secure processor 20 has a core 21 that executes a command code, an encryption key hold part 25 that holds a processor key, and an encryption processing part 24 that encrypts or decrypts data input/output to/from the core 21 with a processor key, and memory 30 stores data input/output to/from core 21. In addition to these, there are provided a built-in ROM 23 for activating the CPU core 21, an internal bus 22 that connects each block, etc. As shown schematically, the encryption key hold part 25 has a hardware register 26 that holds a hardwired encryption key that cannot be rewritten and a write only register 27 in which a encryption key for instruction to be input is stored and which disables read of the stored encryption key for instruction, and outputs the hardware encryption key held in the hardware register 26 as a processor key when the processor is activated and outputs the command encryption key held in the write only register 27 as a processor key when the command encryption key is written to the write only register 27. The memory 30 has program data 31, which is the key transformation program encrypted with a hardware encryption key and supplied to the user from the manufacturer of the secure processor for carrying out transformation to write the input command encryption key to the write only register 27, a encryption key for instruction (encryption setting information) the user determines independently, and a processing program 33 encrypted with the encryption key for instruction 32. The memory for encryption 30 may be provided inside or outside the secure processor 30.

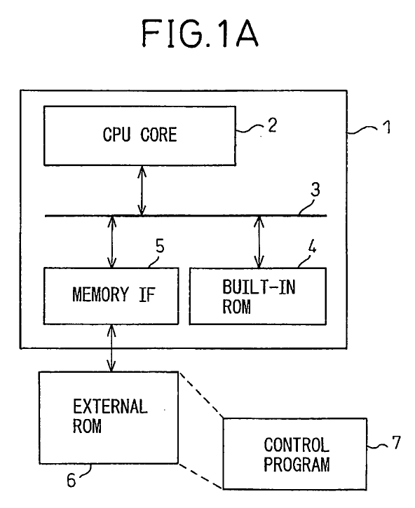

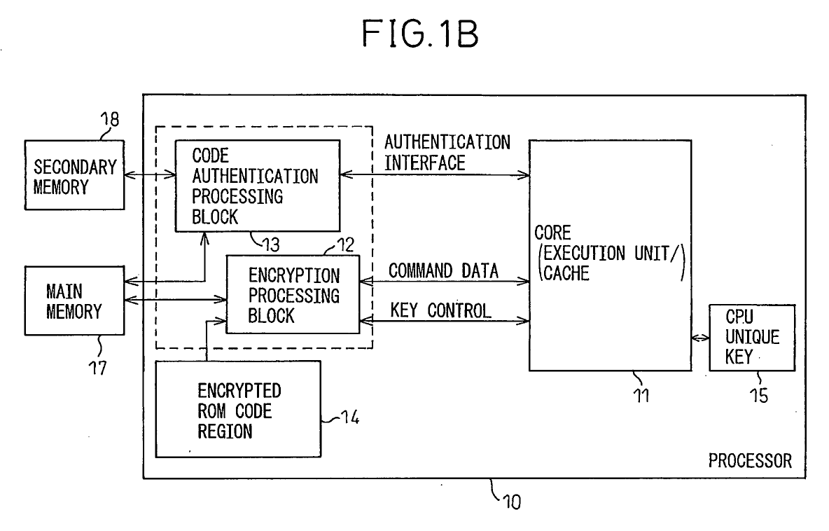

According to the embodiment, the key transformation program is encrypted using a same key of hardware encryption key that cannot be rewritten and only the authorized key transformation program can change the processor key from the hardware encryption key to the encryption key for instruction the user sets arbitrarily. In this manner, by activating with a hardware encryption key that cannot be accessed from software and transforming it into an arbitrary encryption key for instruction, an encryption key for instruction for each user can be set without the need to use the hardware encryption key unique to the chip. In this configuration, the key transformation program, the encryption key for instruction, and the processing program are stored in the memory for encryption that provided by the user, and therefore, it is only required for the secure processor to add the encryption processing part 24 and the encryption key hold part 25 to the conventional configuration (FIG. 1A), i.e., the secure processor can be realized with the addition of minimum modules.

According to the embodiment, the manufacturer supplies only the data of the key transformation program encrypted with the hardware key to the user and it is not necessary for the user to know the hardware key itself. In addition, the user only determines a command encryption key arbitrarily and stores it in the encryption memory and it is not necessary to inform the manufacturer of the encryption key for instruction. Provided the hardware encryption key does not leak out, it is possible to ensure the correct execution of both the key transformation program encrypted with the hardware encryption key and the program encrypted with the command encryption key after being changed. Further, information about the encryption is encrypted and stored in the memory (ROM) and it is very difficult to analyze it alone.

Therefore, it is possible for the manufacturer to use a hardware key common to a plurality of users and there is no need of management because the manufacturer does not know the encryption key for instruction of each user, and thus the management of the encryption key is very easy. In addition, because the manufacturer does not know the command key, there is no possibility of the leak of the command key from the manufacturer and the user can further improve the security.

It is desirable that the encryption key for instruction (encryption setting information) 32 be RSA (Rivest Shamir Adleman). The manufacturer determines a setting information secret key and a public key for RSA encryption and supplies the public key to the user. The command encryption key (encryption setting information) 32 that the user has determined arbitrarily is encrypted with the public key for RSA encryption and stored in the memory for encryption 30. The RSA-encrypted encryption key for instruction 32 is decrypted with the setting information secret key and the decrypted encryption key for instruction is set in the write only register 27. Because the encryption key for instruction is RSA-encrypted, decryption of it is very difficult. In this configuration, the user is not likely to know the setting information secret key.

It is desirable that the encryption processing part carry out encryption and decryption using AES encryption. This is because the amount of data of the key transformation program and the control program is large and high-rate processing is required.

In contrast to this, it is desirable that the encryption key for instruction be RSA-encrypted as described above. This is because encryption and decryption of the encryption key for instruction are carried out separately, high confidentiality is required, and the target of encryption is only the encryption key for instruction and therefore the amount of data is small.

The setting information secret key can be stored in the secure processor; however, it may also be possible to add it to the key transformation program and supply the data from the manufacturer to the user, which is the key transformation program including the setting information secret key encrypted with the hardware encryption key. Because the setting information decryption key is encrypted, the user cannot know the setting information decryption key also in this case. The user stores the key transformation program including the setting information decryption key in the memory. When the secure processor is activated, the key transformation program is decrypted with the hardware encryption key as described above, and therefore, the setting information decryption key is extracted therefrom and the RSA-encrypted command encryption key is decrypted.

Further, it may also be possible to store the electronic signature generated by the user. The program to verify the electronic signature may be provided in the secure processor 20 or in the memory for encryption 30. In this configuration, the creator (user) of the program encrypted with the encryption key for instruction creates a signature public (verification) key in advance and informs the manufacturer of it, and the electronic signature created by the creator (user) of the program is verified with the signature public key and thereby the function of confirming the validity of the program encrypted with the encryption key for instruction can be added. The signature public key is for verifying the electronic signature and even if the signature public key leaks out, it is not possible to generate an authorized signature using the key. When the command public key leaks out, it is possible to create an unauthorized program using an unauthorized key, however, unauthorized execution can be prevented by the signature verification.

It is desirable that the electronic signature be carried out by the RSA scheme for the same reason as that for the command encryption key.

The signature public key is an encryption key the user sets independently and if it is stored in the secure processor, the need arises to manufacture the secure processor for each user, and this is undesirable. Therefore, it is desirable that the signature public key also be encrypted with the hardwired key in the key transformation program and stored.

The manufacturer informs the user of the setting information public key and the user informs the manufacturer of the signature public key, and the manufacturer supplies to the user the data, which is encrypted by the hardwired encryption key and contains the key transformation program including the setting information secret key and the signature public key. The user creates ROM data by combining the encrypted data with the encryption key for instruction encrypted with the setting information public key, the electronic signature, and the control program encrypted with the command encryption key. Because the data supplied to the user from the manufacturer is encrypted, the user cannot know the setting information secret key. In addition, the manufacturer cannot know the signature secret key the user has determined.

In the configuration in which an electronic signature is verified, it may also be possible to provide a function of connecting the connection detection signal of the debugger to the encryption processing part and terminating the command decryption processing when the debugger is detected. Due to this, it is possible to protect the program from the attack using the fact that the command decrypted for execution exists in the CPU core 21 and in this state, the information in the CPU core 21 is taken out using the debugger.

Further, in the extraction (decryption) processing of the encryption key for instruction, the authentication of the authorized user authentication code may be included in addition to the processing of the encryption key for instruction. In this configuration, it is possible to add the function of determining an authorized user by, after adding an authorized user authentication code to the encryption key for instruction that only the creator of the program encrypted with the encryption key for instruction can set, carrying out encryption of the public key in the RSA scheme, and storing the authorized user authentication code in the register.

Further, it may also be possible to provide a register capable of being accessed by the debugger and of storing a value to be compared with the authorized user authentication code and a function of canceling the decryption termination processing when the value matches with the authorized user code. In this configuration, it is possible to provide an environment that can be used even when the debugger is connected only to the creator of the program encrypted with the encryption key for instruction.

The above configuration may be such that the (built-in) ROM 23 connected to the processor core 21 without the interposition of the encryption processing means 24 and which records a program for determining the encryption state of the memory for encryption 30 is provided. In this configuration, the built-in ROM 23 includes the encryption state determination program and thereby verification whether the memory for encryption ROM 30 is mounted is enabled, and at the same time, the processor configuration may be made common to both purposes of encryption and non-encryption.

Further, it is desirable that the memory for encryption 30 is a nonvolatile memory that can be rewritten, such as a flash ROM etc., and the memory for encryption 30 is provided inside or outside the secure processor 20. In this configuration, it is possible to easily change the activation settings using external data by describing the identifier of encryption state in a specific region of the external memory because whether or not it is an encryption program can be determined.

Further, the hardware register 26 that stores the hardwired encryption key can store, for example, a plurality of hardwired encryption keys and may have a configuration in which arbitrary key can be selected from among the plurality of keys. In this configuration, a plurality of hardwired encryption keys can be selected with arbitrary numbers and it is possible to continue the manufacture of the secure processor by selecting a new number when the hardwired encryption key leaks out.

According to the embodiment, the encryption key of the secure processor is transformed from a hardwired encryption key that cannot be rewritten into an encryption key for instruction which the user arbitrarily determines with a key transformation program encrypted with the hardware encryption key, and therefore, it is possible for the user to set the encryption key of the secure processor independently without the need to inform the manufacturer and the maintenance of the secret of the encryption key is easy. In addition, the key transformation program and the encryption key for instruction can be stored in the external memory and it is possible to realize a configuration that can be easily added to a general processor while modules to be added to the processor are minimized and production cost is kept low by integrating the transformation of the hardwired encryption key into an arbitrary key and the encryption processing hardware into a single block.

Further, if the command encryption key is RSA-encrypted, it is difficult to know the command encryption key from the outside and the keeping of the secret of the command encryption key is put under stricter surveillance.

Furthermore, authentication of a program is carried out with an electronic signature and the command encryption key is prevented from being set when any falsification is detected, thereby the security and reliability of the system including the secure processor can be further improved.

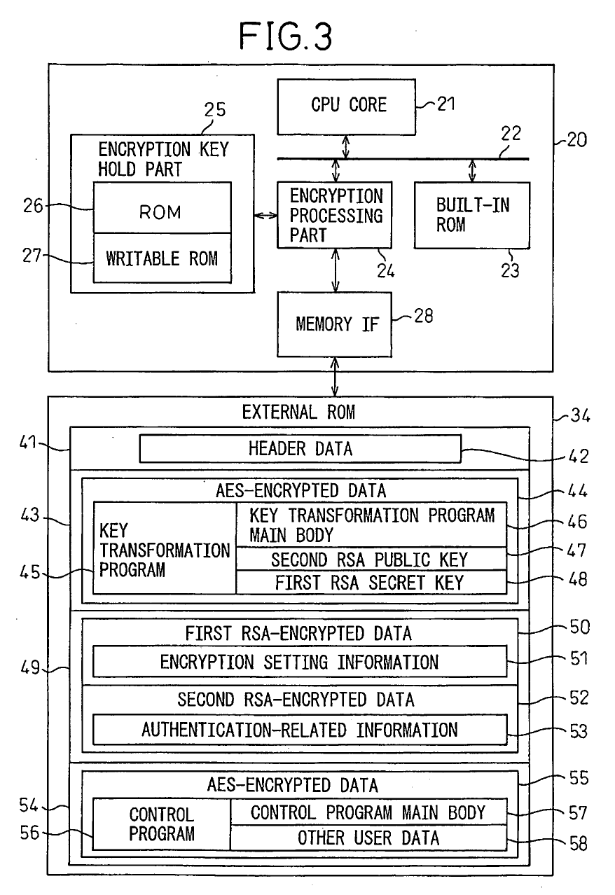

FIG. 3 is a diagram showing the general configuration of a secure processor system according to a first embodiment. As shown schematically, the system includes a secure processor 20 and an external ROM 34 for encryption. Similar to the conventional example, other RAM, I/O interface, etc., are also connected, however, they do not directly relate to the present embodiment, and therefore, their explanation is omitted. The secure processor 20 has a CPU core 21, an internal bus 22, a built-in ROM 23, an encryption processing part 24, an encryption key hold part 25, and a memory IF 28. The encryption processing part 24 carries out encryption processing and decryption processing of input and output between the CPU core 21 and the memory IF with a processor key output from the encryption key hold part 25. The encryption key hold part 25 has a ROM 26 that cannot be rewritten or accessed from the outside and a writable ROM 27 that can be written but cannot be accessed from the outside, and in the ROM 26, a hardware (HW) encryption key is stored and in the write ROM 27, a command encryption key is written after activation. In the present embodiment, the ROM 26 includes a plurality of registers that store a plurality of hardware encryption keys and has a selection circuit for selecting one of the plurality of hardware encryption keys with a HW encryption number and is able to output the selected hardwired encryption key; however, it may also be possible for ROM 26 to store only one hardware encryption key. The system is configured so that the hardwired encryption key selected from the ROM 26 is output to the encryption processing part 24 as a processor key when activated and after a command encryption key is written to the write ROM 27, the command encryption key is output from the write ROM 27 to the encryption processing part 24 as a processor key. The built-in ROM 23 is an indispensable component in the present embodiment and its internal details are described later. These components are integrated into one-chip semiconductor.

The external ROM 34 includes, for example, a rewritable flash ROM etc., and internally stores a ROM header (Encrypted ROM Identifier) 41, a key transformation program 43, RSA-encrypted data 49, and a control program 54. The ROM header (Encrypted ROM Identifier) has header data 42. The key transformation program 43 has AES-encrypted data 44. The AES-encrypted data 44 has a key transformation program 45 AES-encrypted with a hardwired encryption key and the key transformation program 45 AES-encrypted with the hardwired encryption key has a key transformation program main body 46, a second RSA public key 47, and a first RSA secret key 48. The RSA-encrypted data 49 has first RSA-encrypted data 50 and second RSA-encrypted data 52, and the first RSA-encrypted data 50 has encryption setting information 51 and the second RSA-encrypted data 52 has authentication-related information 53. The first RAS-encrypted data 50 and the second RSA-encrypted data 52 are encrypted with different encryption keys. The control program 54 has AES-encrypted data 55 AES-encrypted with the command encryption key and an AES-encrypted control program 56 is included therein. The AES-encrypted control program 56 has a control program main body 57 and other user data 58.

In the encryption processing part 24, with the processor key output from the encryption key hold part 25, the data in the direction of output is AES-encrypted and the data in the direction of input is subjected to the AES decryption processing, respectively. Because of this, the data in the external ROM is encrypted. In the present embodiment, the hardware encryption key inside the chip of the secure processor 20 is not different from each another and is commonly used for chips, and thus reduction in manufacturing costs can be achieved. According to this constitution, the key is common to the users of the processor and although it is possible to prevent deciphering by a third party, the secret information between users cannot be protected. In the present embodiment, therefore, the hardware encryption key of the chip is used only for encrypting a key transformation program created by the manufacturer and the hardwired encryption key information is not distributed to anyone except for the manufacturer.

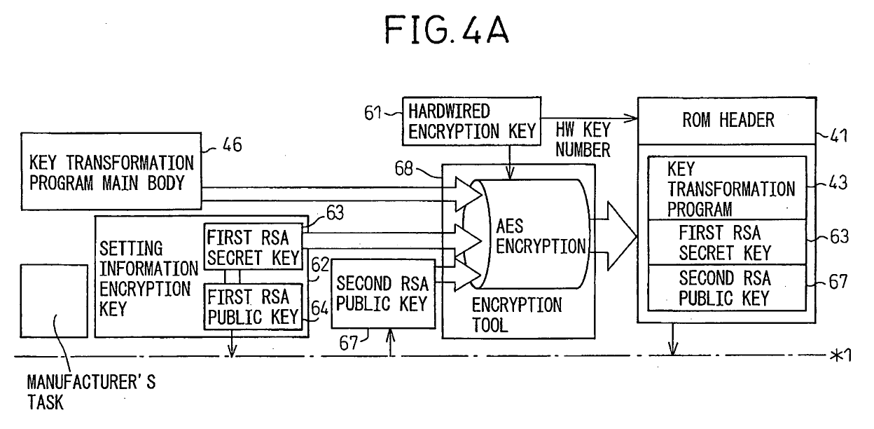

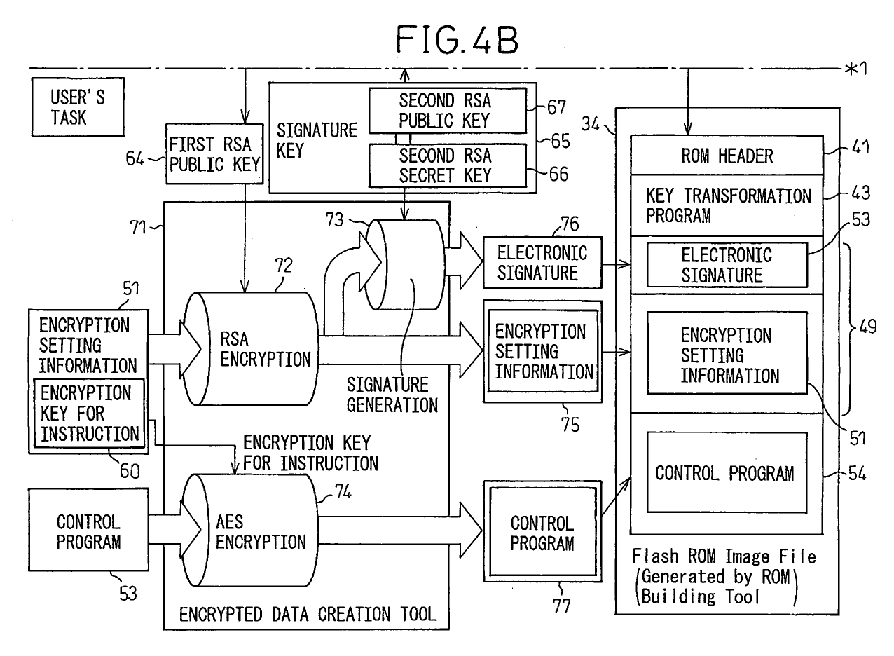

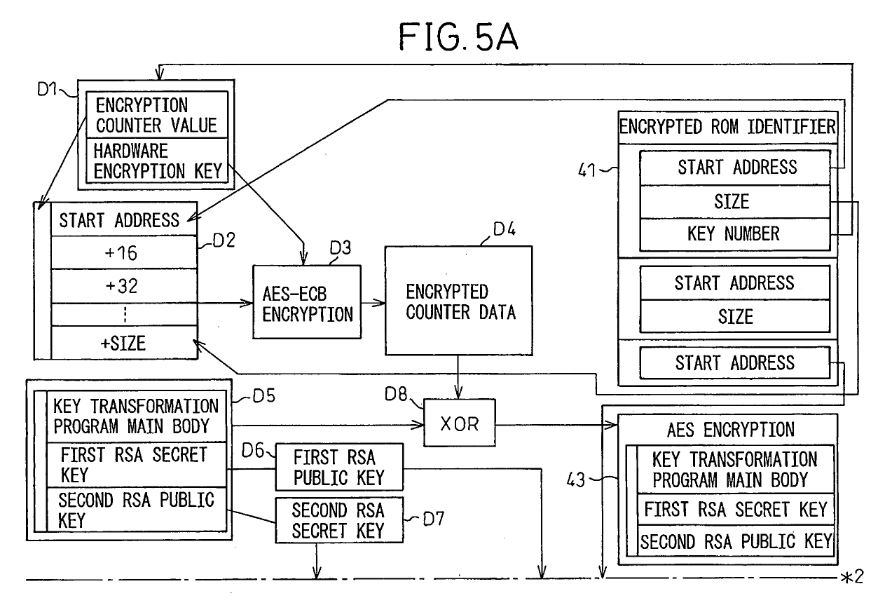

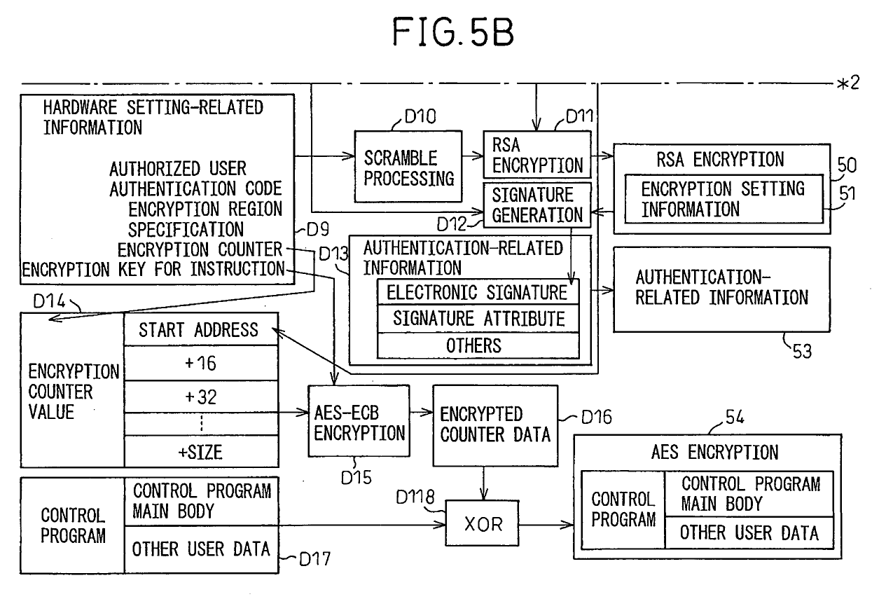

FIGS. 4A and 4B are diagrams for explaining a procedure for creating data to be stored in the encryption (external) ROM 34 and FIGS. 5A and 5B are diagrams showing the flow of data. FIG. 4A shows the work of the manufacturer and FIG. 4B shows the work of the users. First, with reference to FIG. 4 and FIG. 5, data to be stored in the external ROM 34 will be explained.

The manufacturer of the chip of the secure processor 20 selects one from among a plurality of (HW) hardwired encryption keys (D1) and determines a hardwired (HW) encryption key 61 for AES encryption common to each chip, and the hardware encryption key 61 is kept under strict surveillance so as not to be leaked to the outside. In addition, the manufacturer prepares the key transformation program main body 46 that stores a command key read from the external ROM 34 in the writable ROM 27. Further, the manufacturer determines a setting information encryption key 62 including a first RSA secret key 63 and a first RSA public key 64, and the first RAS secret key 63 is kept under strict surveillance so as not to be leaked to the outside and the first RSA public key 64 is supplied to the user.

On the other hand, the user generates the encryption setting information 51 including a command encryption key 60 for AES encryption and the control program 53. Further, the user determines a signature key 65 including a second RSA secret key 66 and a second RSA public (verification) key 67, and the second RSA secret key 66 is kept under strict surveillance so as not to be leaked to the outside and the second RSA public key 67 is supplied to the manufacturer.

The manufacturer generates a counter value (D2) in a CTR mode of which program size corresponds to the selected hardware encryption key. This is encrypted in an ECB mode (D3) and encrypted counter data (D4) is generated. Then, the data integrating the key transformation program main body 46, the first RSA secret key 63, and the first RSA public key 67 supplied from the user is AES-encrypted with the hardware encryption key 61 in an encryption tool 68. Specifically, encryption processing is completed by calculating the exclusive-OR (XOR) (D8) of the data and the data of the key transformation program (D5) and thus the encrypted key transformation program 43 is generated. The key transformation program 43 is generated for each user. Then, the ROM header 41 created based on the HW key number that specifies the used hardware encryption key is combined with the key transformation program 43 AES-encrypted in the encryption tool 68, and supplied to the user as program data. The key transformation program 43 includes first RSA secret key 63 and second RSA public key 67 in the AES-encrypted form.

The user creates RSA-encrypted encryption setting information 75 by RSA-encrypting the encryption setting information 51 including the encryption key for instruction 60 for AES encryption with the first RSA public key 64 in an RSA encryption part 72. Further, an electronic signature 76 is created by RSA-encrypting data, which is hash-processed RSA-encrypted encryption setting information 75 with the second RSA secret key 66 in a signature generation part 73. Then, in an AES encryption part 74, a control program 77 AES-encrypted with the encryption key for instruction 60 is created using the encryption key for instruction 60 by encrypting, as D14, D15, and D16, using the counter data and the command encryption key included in the information and subjecting them to the XOR (D18) operation with the data D17 of the control program. The above processing is carried out using an encrypted data creating tool 71. Then, the RSA-encrypted encryption setting information 75, the electronic signature 76, and the AES-encrypted control program 77 created as above are combined with the program data including the ROM head 41 and the key transformation program 43 supplied from the manufacturer and written to the external ROM 34. In this manner, the external ROM is completed.

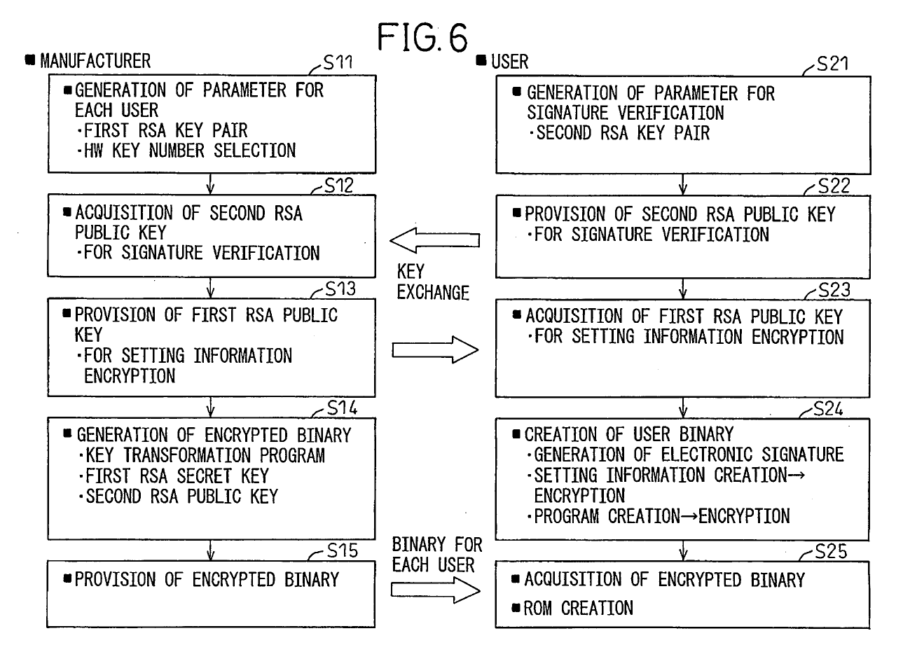

FIG. 6 is a flowchart showing a procedure for creating the encryption ROM 34 on the manufacturer side and the user side. It is assumed that a secure processor that stores in advance a plurality of hardwired encryption keys has already been manufactured and the key transformation program main body 46 has also been created. The hardware encryption key can be selected by the setting from the outside. In step S11, a parameter for each user, which includes the setting information encryption key pair (the first RSA key pair) 62 and the HW key selection number, is generated. On the other hand, on the user side, a parameter for signature verification including the second RSA key pair 65 is created in step S21.

In steps S21 and S22, the second RSA public key 68 for signature verification is supplied from the user side to the manufacturer side and the manufacturer obtains the second RSA public key 67. In other words, the exchange of the second RSA public key 67 is carried out.

In steps S13 and S23, the first RSA public key 64 for encryption setting information is supplied from the manufacturer side to the user side and the user obtains the first RSA public key 64. In other words, the exchange of the first RSA public key 64 is carried out.

On the manufacturer side, in step S14, encrypted binary data, which is the AES-encrypted data including the key transformation program 46, the first RSA secret key 63, and the second RSA public key 67, is generated. The encrypted binary data cannot be decrypted on the user side.

On the other hand, the user side creates setting information and RSA-encrypts it with the first RSA public key 64 obtained from the manufacturer, and creates a control program and encrypts it with the command encryption key, and further generates an electronic signature in step S24.

In step S15, the manufacturer supplies the encrypted binary data generated in step S14 to the user and the user can obtain the encrypted binary data.

In step S25, the user creates the external ROM 34 by combining the obtained encrypted binary data, the encrypted setting information created in step S24, the encrypted control program, and the electronic signature.

Then, the user manufactures a system by combining the secure processor supplied from the manufacturer, the external ROM 34 created as described above, and other components.

As described above, only the second RSA public key for signature verification is supplied to the manufacture from the user, and therefore, it is not likely that the manufacturer can obtain the command encryption key the user has determined independently. In addition, only the first RSA public key for encrypting setting information and the encrypted binary data are supplied to the user from the manufacturer, and therefore, it is not likely that the user can obtain the hardware key and the first RSA secret key the manufacturer has determined independently.

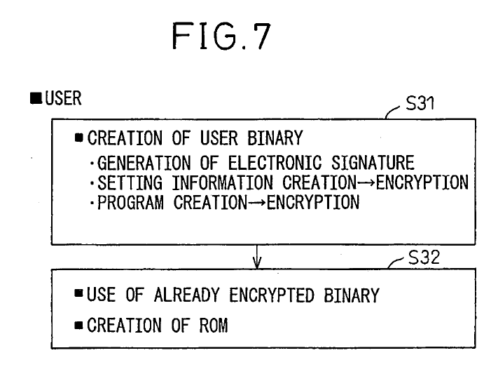

There may be the case where it is necessary to modify the control program for some reason on the user side after the external ROM for encryption is created as shown in FIG. 6. FIG. 7 is a flowchart showing a procedure for updating the external ROM. It is not necessary for the manufacturer to be involved with the procedure and all of the update procedures can be done on the user side.

In step S31, the user creates a new control program and AES-encrypts it with the encryption key for instruction, and RSA-encrypts it with the first RSA public key 64 created previously and combines it with the setting information and the electronic signature, and creates the external ROM by combining it with the encrypted binary data supplied previously from the manufacturer in step S32.

The encrypted data stored in the external memory 34 for encryption is described as above. Because the stored contents of the external ROM 34 consist of three parts and each of them is encrypted, it is possible to construct a structure that cannot be deciphered by third parties or the users of the processor. Although the common key encryption processing of the processor key (the hardwired key and the encryption key) is described with the AES system as a representative system and the public key encryption system for encrypting setting information and authenticating signature is described with the RSA system as a representative system, any equivalent system may be used. The encryption key for instruction for encrypting the control program created by the user is encrypted with the first RSA public key; however, in the RSA encryption system, the public key differs from the secret (decryption) key, and therefore, it is not likely that the user will know the secret key even if the public key is revealed to the user, and the user alone can encrypt the command encryption key for the defined control program. Due to this, the user can carry out encryption of the program without explicitly notifying the command encryption key, which is confidential information, to the manufacturer.

Next, the internal configuration of the secure processor 20 that processes such encryption data will be explained below. First, the basic operations of the secure processor 20 will be explained. The secure processor 20 executes the key transformation program 43 encrypted with the hardwired encryption key 61 stored in the ROM 26 in the chip while decrypting it by the encryption processing part 24 supplied with the in-chip hardwired encryption key, and in the key transformation program 43, the encryption key for instruction 60 for the control program encrypted with the first RSA public key 64 is extracted and is set in the writable ROM 27. Due to this, the encryption processing part 24 is set so that it encrypts and decrypts with the encryption key for instruction 60. In this manner, key transformation is carried out so that the control program 54 created by the user of the secure processor 20 can be decrypted correctly. After the key transformation, the encryption processing part 24 decrypts the encrypted control program 54 and thus correct execution is enabled.

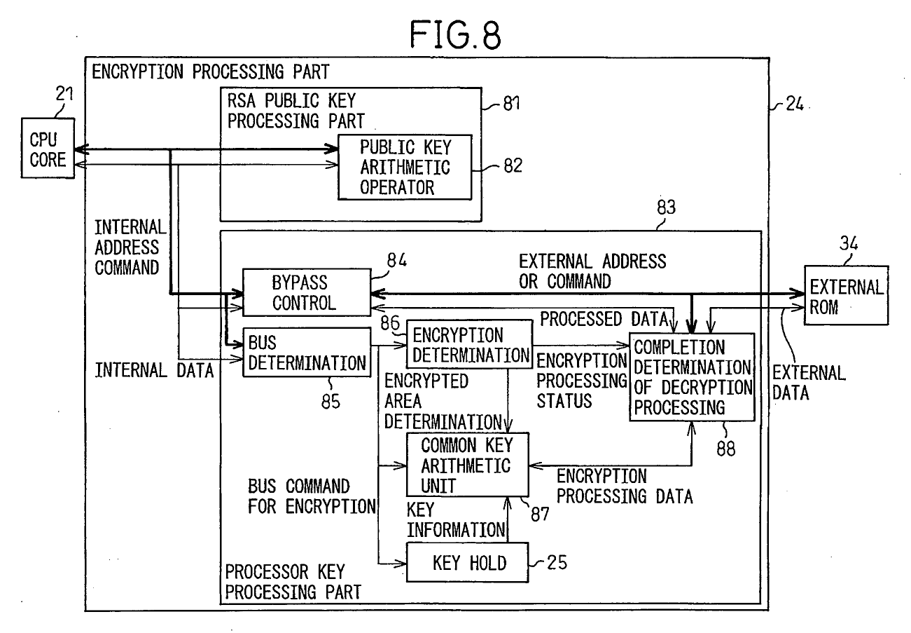

FIG. 8 shows the internal configuration of the encryption processing part 24. The encryption processing part 24 consists of an RSA public key processing part 81 and a processor common key processing part 83. The RSA public key processing part 81 is mounted on a public key arithmetic operation unit 82 for improving the RSA processing rate and therefore it is not requisite as a constituent component in the present embodiment, however, it is provided from the standpoint that the addition to an already existing system is facilitated. The processor common key processing part 83 includes some small blocks of a bus determination part 85 for determining whether or not the command from the interface on the CPU core 21 side is directed to the module of its own (the processor common key processing part 83), a bypass control part 84 used when the encryption function is off, an encryption determination part 86 for determining whether or not the command is directed to the module of its own is an object of encryption, a common key arithmetic unit 87 for carrying out AES key encryption or decryption processing with a processor key, the encryption key hold part 25 for supplying the key to the common key arithmetic operation part 87, and a completion determination of decryption processing part 88 for carrying out encryption and decryption processing, and completion determination.

Next, the dataflow in the encryption processing part 24 will be explained. When the read of the external ROM 34 from the CPU core 21 and decryption processing are carried out, the setting of the processor key information is done in advance. When the key transformation program described above is executed for the encryption key hold part 25, the setting is not necessary, or a HW key number that specifies which key is selected from among several keys is set. Similarly, in the encryption determination part 86, information on whether the target address is encrypted is set in the encryption determination part 86. After these settings, a read command for the external ROM 34 is transmitted from the CPU core 21 to the encryption processing part 24 via the internal bus 22. The bus determination part 85 transmits the determination direction whether it is the target of encryption and the key setting direction, respectively, to the encryption determination part 86 and the encryption key hold part 25 and each block transmits the encryption determination result and the key information to the common key arithmetic unit 87. The common key arithmetic unit part 87 carries out decryption processing of the information based on the address information based on the information and the activation signal from the bus determination part 85. After the decryption processing, the operation result is transmitted to the completion determination of decryption processing part 88. In parallel with this, a read command is issued to the external ROM 34 via the bypass control part 84 and the external address/command bus. As a result of this command, data is received from the external ROM 34 after a fixed time elapses, and in the completion determination of decryption processing part 88, and after the processing of the data of the external ROM 34 and the processor key operation processing are synchronized with each other, the operation is carried out and the result is returned to the CPU core 21 via the processing bus and the internal bus. The operation in the completion determination of decryption processing part 88 is carried out in the CTR mode.

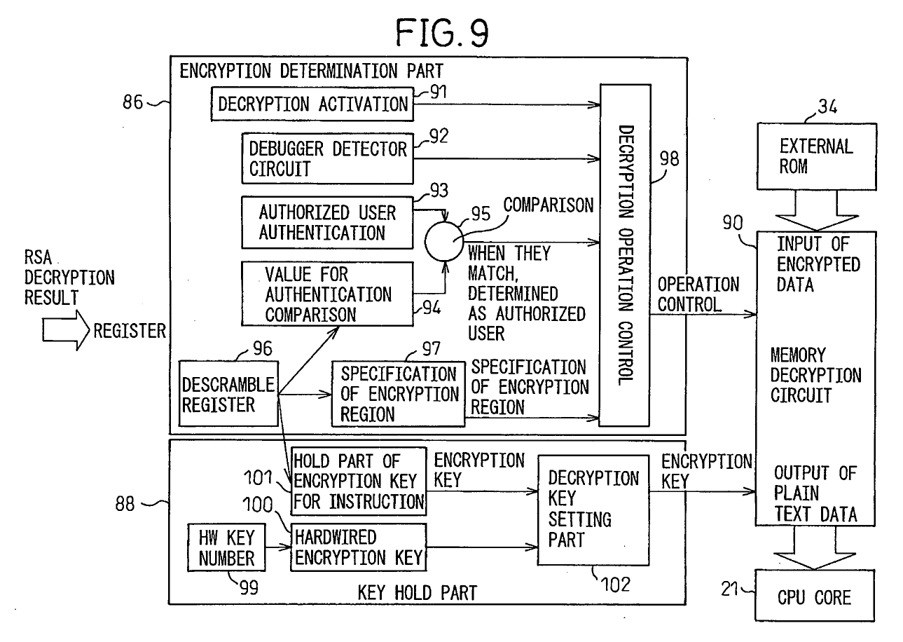

FIG. 9 is a diagram showing the configuration of the encryption determination part 86 and the encryption key hold part 88. As shown schematically, the encrypted data of the external ROM 34 is decrypted in a memory decryption circuit 90 with the processor key and supplied to the CPU core 21. A hardwired encryption key hold part 100 corresponds to the ROM 26 in FIG. 4. The hardwired encryption key hold part 100 stores a plurality of hardwired encryption keys and is configured so that one of the plurality of the hardwired encryption keys is selected by the HW key number held in a HW key number register 99 and output. The HW key number is set from the outside of the secure processor 20 via the input/output terminals or set by subjecting the chip to the post processing. A hold part of encryption key for instruction 101 corresponds to the write ROM 27 in FIG. 4. When signature authentication is carried out with the authorized key transformation program 43, the command encryption key included in the encryption setting information is decrypted and written to the hold part of encryption key for instruction 101. Before the command encryption key is written to the hold part of encryption key for instruction 101, a decryption key setting part 102 holds the fixed encryption value output from the hardwired encryption key hold part 100 and outputs it to the memory decryption circuit 90 as a processor key and after the memory encryption key is written to the hold part of encryption key for instruction 101, outputs the command encryption key to the memory decryption circuit 90 as the processor key. In other words, the hardware encryption key becomes invalid when the command encryption key is set. If the hardwired encryption key hold part 100 holds one hardware encryption key, the HW key number register 99 is not necessary.

The encryption determination part 86 has a decryption activation register 91, a debugger detector circuit 92, an authorized user authentication data hold part 93, an authentication comparison value hold part 94, a comparator 95 that compares the value of the authorized user authentication data hold part 93 with the value of the authentication comparison value hold part 94, a descramble register 96, an encryption region specifying register 97, and a decryption operation control part 98. These are described later.

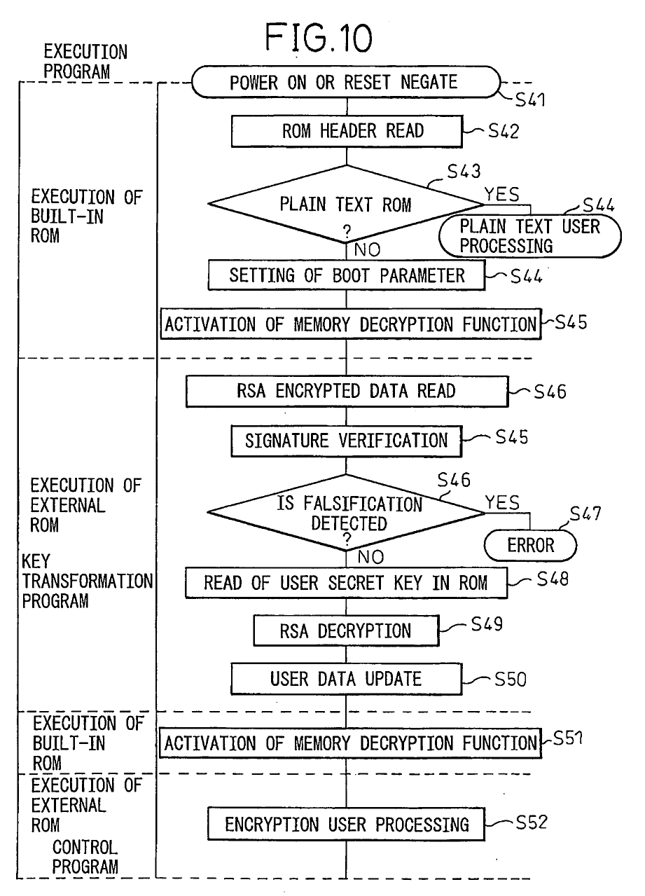

FIG. 10 is a flowchart showing the operations in the secure processor system in the present embodiment. The operations are explained along with the dataflow shown in FIG. 5. In the flowchart in FIG. 10, the item of execution programs on the left-hand side indicates the recorded position of the execution program at the point of time.

When power is turned on in step S41, the activation program recorded in the built-in ROM 23 is processed. In step S42, the program in the built-in ROM 23 first reads the header data 42 in the external ROM 34. In the header data 42, information as to whether or not it is an encryption ROM and information about the arrangement of each data when it is an encryption ROM are recorded in plain text as described in the ROM header 41 in FIG. 5. In step S43, when the read header data is a plain text ROM, the procedure proceeds to step S44 and processing relating to encryption is not carried out and normal activation is carried out. When it is an encryption ROM, the procedure proceeds to step S44 and the setting of boot parameters is carried out based on the ROM header. Specifically, the setting is to set the encryption key number indicated in the ROM header 41 to the HW key number register 99 (FIG. 8) and to hold each address information. This corresponds to the setting of the data 41 in FIG. 5.

Subsequently, in step S45, the memory decryption function is activated by setting it to the decryption activation register 91. This brings about a state in which read is possible while decrypting the data in the external ROM 34. After that, the program branches into the key transformation program 43. The key transformation program 43 is a program created by the chip manufacturer and encrypted with the hardwired encryption key specified by the encryption key number described above. After branching, the program starts the processing of the key transformation. In the key transformation processing, first in step S46, the RSA-encrypted data part is read and decrypted. The RSA-encrypted data part includes the encryption setting information 51, which is information about hardware setting encrypted in the RSA scheme, and the authentication-related information 53, which is the information 51 subjected to the electronic signature. The verification key (the second RSA public key) for signature verification and the RSA secret key (the first RSA secret key) for decryption are held in advance in the key transformation program 43 as described above.

The signature part of the RSA-encrypted data part read in step S45 is first verified. In step S46, the verification result is determined and if it is determined that the signature has been falsified, the procedure proceeds to step S47 and error processing, that is, execution stop processing is carried out. When not changed with malicious intent, the RSA-encrypted data part in the external ROM 34 is read in step S48 and the encryption setting information 51 is decrypted from the RSA-encoded data part in step S49. The encryption setting information 51 includes an authorized user authentication code, encryption region specification, encryption counter, and command encryption key, and after inverse transformation processing D10 is carried out by hardware based on the information, each data is reflected in the hardware. When the ROM data is created, the encryption setting information 51 is generated through the scramble processing D10 and the RSA encryption processing D11 in FIG. 5. The decrypted encryption setting information 51 is set at a time to the descramble register 96 in FIG. 9. This processing corresponds to the user data update processing in step S50 in FIG. 10. In this processing, the encryption key for instruction is set in the hold part of encryption key for instruction 101 and the processor key is changed, however, if the decryption key is changed at once, it is not possible to correctly decrypt the program being executed in the encrypted state. In the present embodiment, with the timing when the decryption activation register 91 in FIG. 9 is rebooted, the key for decryption processing is updated. For security, the flow returns to the built-in ROM 34 and the decryption function is activated in step S51. In the current state, the encryption key for instruction for the user control program is set to the hardware (the write ROM 27) correctly and a state in which decryption is possible is brought about. After this, in step S52, the program branches into the user program and it are possible to execute the program in the same way as that of the normal program. When the user program is executed, it is not possible to correctly read the key transformation program created by the manufacturer and the security of each secret key can be maintained.

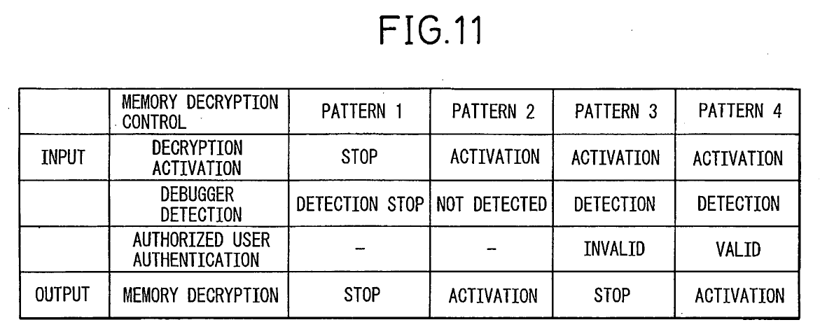

Returning to FIG. 9, other functions are explained. When the RAS decryption result in FIG. 9 is set to the descramble register 96, the encryption region specification and the authentication comparison value 94 are set to the registers 94, 97 together with the encryption key for instruction. The encryption region specification is a function capable of specifying whether or not encryption is carried out for each fixed unit of address. The authentication comparison value is used to authenticate whether or not the user is authorized. The RSA-encrypted data is defined by each combination of D5=D6, D5=D7 in FIGS. 5A and 5B, and as described above, the manufacturer creates the first RSA key pair for encrypting the encryption setting information and after the user creates the second RSA key pair about the signature, the data corresponding to each public key is exchanged. By the key exchange, execution is possible only when the authorized user creates data correctly. The authentication comparison value is encrypted by the information, and therefore, it is possible to state that the information cannot be known unless the information defined when the control program is encrypted is known. The encryption determination part 86 compares authentication comparison values of the authorized user authentication register 93 capable of being written from software and the authentication comparison value register 94 at all times, and determines whether or not the user is authorized. This information is used in the processing based on the table in FIG. 11. In the case of pattern 1, the decryption processing is not activated and the encryption program is not in operation, and therefore, a particularly control is not necessary. In the case of pattern 2, although the decryption processing is activated, no debugger is detected, and therefore, it operates regardless of whether or not the user is authorized. This corresponds to the normal operation state. Pattern 3 is the case where the debugger is detected in the case of pattern 2. If the debugger is connected without setting an appropriate value to the register for authorized user authentication, the decryption processing is stopped at once, and therefore, correct execution is not possible. As in the case of pattern 4, the authorized user connects the debugger after setting the authorized user code to the register 93. If user authentication has been carried out correctly, the decryption processing continues even when the debugger is detected. Due to this, it is possible to make deciphering difficult in the processor that operates while decrypting the encryption command.

The embodiment provides a secure processor capable of ensuring the security of the operation in the form that can be added easily to already existing systems.

The embodiment can be applied to a secure processor in which data to be input/output to/from the CPU core is encrypted.

What is claimed is:

1. A secure processor system comprising:
a secure processor having a core that executes a instruction code, an encryption key hold part that holds a processor key, and an encryption processing part that encrypts or decrypts data input/output to/from the core with the processor key; and
a memory that stores the data input/output to/from the core,
wherein the encryption key hold part of the secure processor comprises:
a hardware register that holds a hardwired encryption key that cannot be rewritten or read; and
a write only register that stores a encryption key for instruction to be input and holds the stored encryption key for instruction so that it cannot be read,
wherein the encryption key hold part outputs the hardware encryption key held in the hardware register as the processor key when the processor is activated, and after the command encryption key is written to the write only register, outputs the command encryption key held in the write only register as the processor key.

2. The secure processor system according to claim 1,
wherein the secure processor is connected to the core without the interposition of the encryption processing part, further comprises a ROM (read only memory) that records a program for determining an encryption state of data stored in the memory, and changes activation settings in accordance with a determination result of the encryption state.

3. The secure processor system according to claim 1,
wherein the memory stores plain text or an encrypted program and identification information of the program.

4. The secure processor system according to claim 3,
wherein the memory stores a key transformation program that stores the encryption key for instruction in the write only register in a form encrypted with the hardware encryption key.

5. The secure processor system according to claim 4,
wherein the memory stores the encryption key for instruction in a form encrypted with a setting information public key, and
wherein the secure processor stores a setting information secret key for decrypting the encryption key for instruction which encrypted with the setting information public key so that it cannot be rewritten or accessed from the outside.

6. The secure processor system according to claim 4,
wherein the memory stores the encryption key for instruction in a form encrypted with a setting information public key, and
wherein the key transformation program stores a setting information secret key for decrypting the encryption key for instruction which encrypted with the setting information public key.

7. The secure processor system according to claim 6,
wherein the memory stores a processing program executed in the secure processor in a form encrypted with the encryption key for instruction.

8. The secure processor system according to claim 6,
wherein the encryption processing part carries out encryption and decryption in the AES encryption scheme, and
wherein the encryption of the command encryption key is carried out in the RSA scheme.

9. The secure processor system according to claim 6,
wherein the memory stores an electronic signature encrypted with a signature secret key, and
wherein the key transformation program stores a signature public key for verifying the electronic signature.

10. The secure processor system according to claim 6,
wherein the memory stores an electronic signature encrypted with a signature secret key,
wherein the key transformation program stores a signature public key for verifying the electronic signature, and
wherein the secure processor stores a program for writing the encryption key for instruction to the write only register when the verification of the electronic signature with the signature public key succeeds in a form encrypted with the hardwired encryption key.

11. The secure processor system according to claim 9,
wherein the electronic signature is created in the RSA scheme.

12. The secure processor system according to claim 9,
wherein the secure processor connects a connection detection signal of a debugger to an encryption processing part and stops decryption processing with the processor key when a debugger is detected.

13. The secure processor system according to claim 12,
wherein the secure processor further comprises:
a register that stores a user authentication code that can be accessed by a debugger; and
a comparison part that compares the encryption key for instruction with the user authentication code,
wherein the secure processor cancels decryption stop processing when a debugger is connected when the command encryption key matches the user authentication code.

14. The secure processor system according to claim 1,
wherein the encryption key hold part of the secure processor comprises a plurality of the hardwired registers, selects one of the plurality of the hardwired registers, and outputs the one hardwired register as the processor key.

15. The secure processor system according to claim 1,
wherein the memory is provided inside the same chip as the secure processor.

16. The secure processor system according to claim 1,
wherein the memory is provided outside the chip of the secure processor.

17. The secure processor system according to claim 1,
wherein the memory has a nonvolatile memory that cannot be rewritten at least at part thereof.

18. A secure processor, comprising:
a core that executes a command code;
an encryption key hold part that holds a processor key; and
an encryption processing part that encrypts or decrypts data input/output between the core and a memory with the processor key,
wherein the encryption key hold part comprises:
a hardware register that holds a hardwired encryption key that cannot be rewritten; and
a write only register that stores a encryption key for instruction to be input and holds the stored encryption key for instruction so that it cannot be read,
wherein the encryption key hold part outputs the hardware encryption key held in the hardwired register as the processor key when the processor is activated, and after the encryption key for instruction is written to the write only register, outputs the encryption key for instruction held in the write only register as the processor key.

19. A method of controlling a secure processor system comprising:
a secure processor having a core that executes a instruction codes, an encryption key hold part that holds a processor key, an encryption processing part that encrypts or decrypts data input/output to/from the core with the processor key, and a setting information secret key storage part that stores a setting information secret key, wherein the encryption key hold part has a hardware register that holds a hardwired encryption key that cannot be rewritten or read from the outside and a write only register that stores an encryption key for instruction to be input and holds the stored encryption key for instruction so that it cannot be read from the outside, and wherein the encryption key hold part outputs the hardwired encryption key held in the hardware register as the processor key when the processor is activated, and after the encryption key for instruction is written to the write only register, outputs the encryption key for instruction held in the write only register as the processor key; and
a memory that stores data input/output to/from the core,
the method comprising the steps of:
decrypting a key transformation program that stores the encryption key for instruction stored in the memory and encrypted with the hardwired encryption key in the write only register in the encryption processing part at the time of activation;
decrypting the encryption key for instruction stored in the memory and encrypted with a setting information public key with the setting information secret key stored in the setting information secret key storage part and storing it in the write only register; and
setting so that the encryption key hold part carries out encryption or decryption with the encryption key for instruction.

20. The method of controlling a secure processor system according to claim 19,
wherein after the key transformation program is decrypted, a signature public key for decrypting an electronic signature encrypted with a signature secret key is extracted from the decrypted key transformation program;
wherein the electronic signature stored in the memory is decrypted with the signature public key;
wherein verification of the electronic signature is carried out by comparing decrypted signature information and encryption setting information including the decrypted encryption key for instruction; and,
wherein when the verification of the electronic signature succeeds, the encryption key for instruction is written to the write only register.
